(19) United States
(12) Patent Application Publication
(10) Pub. No.: US 2014/0074693 A1
(43) Pub. Date: Mar. 13, 2014

(54) TRACKING FOR ROYALTY DETERMINATION

(71) Applicants: Yu Deng, Yorktown Heights, NY (US); Alexei A. Karve, Mohegan Lake, NY (US); Andrzej Kochut, Croton on Hudson, NY (US); Randy A. Rendahl, Raleigh, NC (US); Anca Sailer, Scarsdale, NY (US); Hidayatullah H. Shaikh, Shrub Oak, NY (US)

(72) Inventors: Yu Deng, Yorktown Heights, NY (US); Alexei A. Karve, Mohegan Lake, NY (US); Andrzej Kochut, Croton on Hudson, NY (US); Randy A. Rendahl, Raleigh, NC (US); Anca Sailer, Scarsdale, NY (US); Hidayatullah H. Shaikh, Shrub Oak, NY (US)

(73) Assignee: International Business Machines Corporation, Armonk, NY (US)

(21) Appl. No.: 13/613,853

(22) Filed: Sep. 13, 2012

(51) Int. Cl. G06Q 20/22

(52) U.S. Cl. 705/39

(57) ABSTRACT

A method including identifying an individual contribution to a compilation, where the compilation comprises a plurality of individual contributions; and determining, at least partially with a computer processor, a royalty distribution value for the identified individual contribution based, at least partially, upon at least one weighted metric regarding the compilation.

### BACKGROUND

1. Technical Field

The exemplary and non-limiting embodiments of the invention relate generally to tracking for determining a royalty and, more particularly, to a royalty for an individual contribution in a compilation.

2. Brief Description of Prior Developments

Royalty distribution is normally based on a business-to-business agreement. On a cloud platform, an individual user can contribute to an image or composed service, and make it public as a catalog item.

### BRIEF SUMMARY

The following summary is merely intended to be exemplary. The summary is not intended to limit the scope of the claims.

In accordance with one aspect, a method comprises identifying an individual contribution to a compilation, where the compilation comprises a plurality of individual contributions; and determining, at least partially with a computer processor, a royalty distribution value for the identified individual contribution based, at least partially, upon at least one weighted metric regarding the compilation.

In accordance with another aspect, a method comprises tracking at least one individual contribution in a compilation of contributions, where the compilation is stored in a memory; and determining a royalty value for the at least one individual contribution based, at least partially, on one or more of: usage of the individual contribution, a rating assigned to the individual contribution by at least one user of the individual contribution, a dependency relationship of the individual contribution in the compilation, a weighting system of the individual contribution relative to at least one other of the contributions in the compilation, and dependability of the individual contribution relative to at least one other of the contributions in the compilation.

In accordance with another aspect, a method comprises using provenance data associated with a catalog item to track an individual contribution in a compilation of contributions, where the compilation is stored in a memory; and dynamically computing a royalty distribution for the individual contribution based, at least partially, upon at least one metric related to the contributions which form the compilation.

### BRIEF DESCRIPTION OF THE SEVERAL VIEWS OF THE DRAWINGS

The foregoing aspects and other features are explained in the following description, taken in connection with the accompanying drawings, wherein:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 is a diagram illustrating one example method;

FIG. 5 is a diagram illustrating one example method;

FIG. 6 is a diagram illustrating one example method;

FIG. 7 is a diagram illustrating a compilation on a cloud system;

FIG. 8 is a diagram illustrating some examples of metrics which may be used to dynamically compute a royalty;

FIG. 9 is a diagram illustrating one example method; and

FIG. 10 is a flow diagram of an example.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

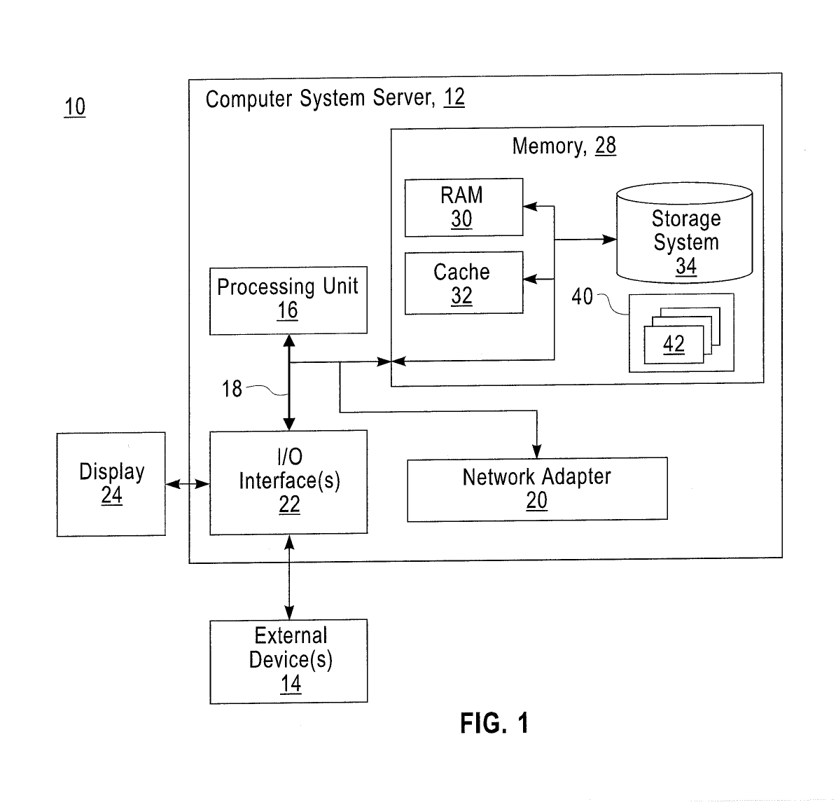

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

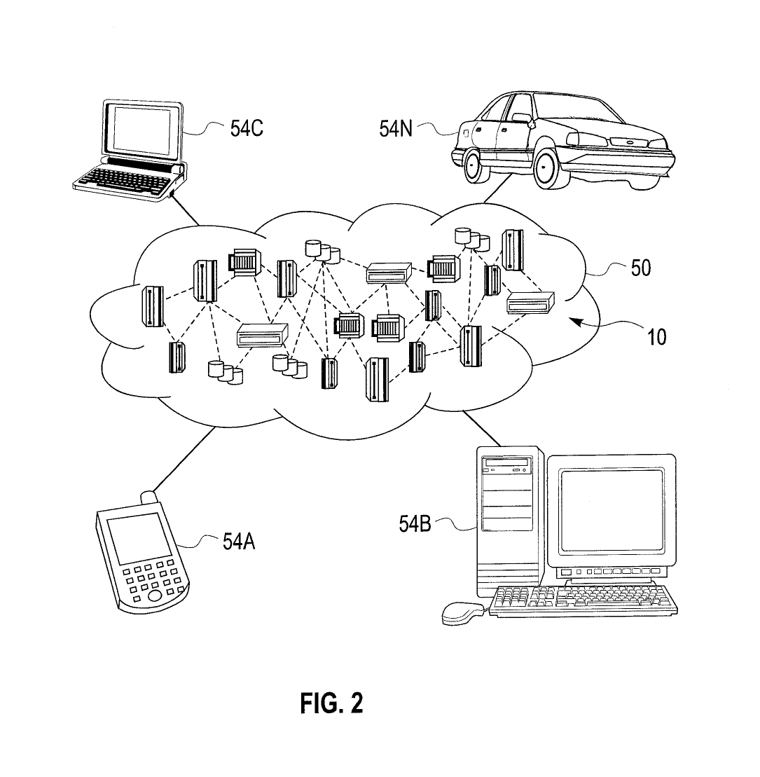

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

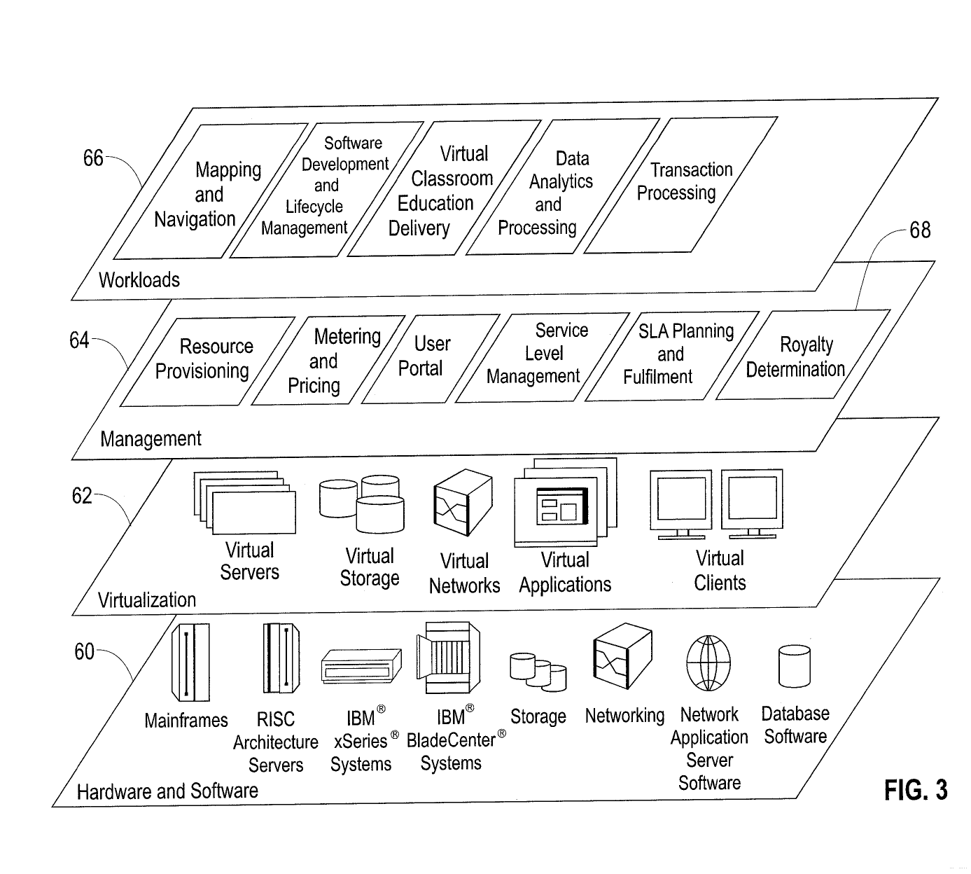

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® ZSERIES® systems; RISC (Reduced Instruction Set Computer) architecture based servers, in one example IBM PSERIES® systems; IBM XSERIES® systems; IBM BLADECENTER® systems; storage devices; networks and networking components. Examples of software components include network application server software, in one example IBM WEBSPHERE® application server software; and database software, in one example IBM DB2® database software. (IBM, ZSERIES, PSERIES, XSERIES, BLADECENTER, WEBSPHERE, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and

Royalty determination 68 may be provided as one of the functions of the management layer 64. As noted above, in the past, royalty distribution was normally based on a business-to-business agreement. Thus, royalty distribution was based on pre-signed agreement. However, it was hard to follow this model for individual contributors on a cloud platform. On a cloud platform, an individual user can contribute to an image or composed service and make it public as a catalog item. Thus, in the past, royalty distribution could not be done at a finer granularity, such as resource usage for example. A feature as described herein is to keep track of individual contributions and contribution value/impact dynamically, and distribute royalty to them.

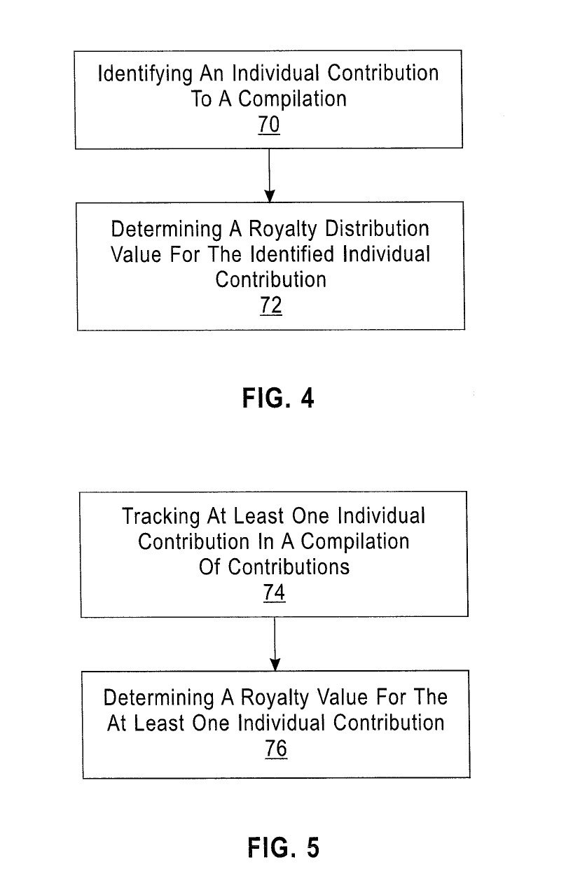

Referring also to FIG. 4, the system may use a method for the royalty determination 68 including identifying an individual contribution to a compilation, where the compilation comprises a plurality of individual contributions as indicated by block 70, and determining, at least partially with a computer processor, a royalty distribution value for the identified individual contribution based, at least partially, upon at least one weighted metric regarding the compilation as indicated by block 72. The plurality of individual contributions may comprise catalog items being offered for example.

The individual contribution may be stored in a memory in a cloud environment. At least some of the plurality of individual contributions may be stored in one or more memories in a cloud environment. The at least one weighted metric may include usage of the individual contribution, by at least one user, relative to usage of at least one other of the plurality of individual contributions of the compilation. The at least one weighted metric may include at least one rating of the individual contribution relative to rating(s) of at least one other of the plurality of individual contributions of the compilation. The at least one weighted metric may include a dependency relationship of the individual contribution relative to at least one other of the plurality of individual contributions of the compilation. It should be noted that an individual contribution of the offering may be a composition of multiple individual contribution bundled together. A “dependency relationship” does not necessarily mean that two components are actually bundled together in one catalog item. The at least one weighted metric may include dependability or a dependability index of the individual contribution relative to dependability of at least one other of the plurality of individual contributions of the compilation or another catalog item. Determining the royalty distribution value may use a weighting system to determine the royalty distribution value for the identified individual contribution. The method may further comprise tracking use of the individual contribution. The method may further comprise using provenance data associated with the individual contribution to track the individual contribution. The method may further comprise dynamically computing the royalty distribution value at different points in time for the individual contribution. The method may further comprise determining a total royalty value to be distributed for the individual contribution for a predetermined period of time based upon the dynamically computed royalty distribution value over that predetermined period of time.

Referring also to FIG. 5, an example system and method may comprise tracking at least one individual contribution in a compilation of contributions as indicated by block 74, where the compilation is stored in a memory; and determining a royalty value for the at least one individual contribution as indicated by block 76. Determining the royalty value for the at least one individual contribution may be based upon, at least partially, on one or more of:
usage of the individual contribution,
a rating assigned to the individual contribution by at least one user of the individual contribution,
a dependency relationship of the individual contribution in the compilation,
a weighting system of the individual contribution relative to at least one other of the contributions in the compilation, and
dependability of the individual contribution relative to at least one other of the contributions in the compilation or another catalog item.

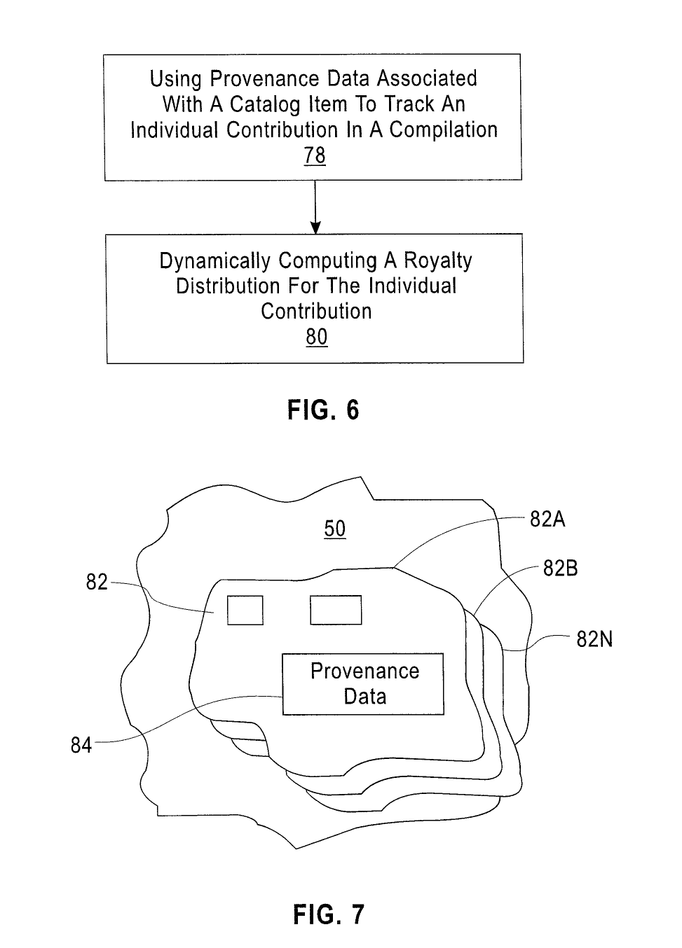

Referring also to FIG. 6, an example system and method may comprise using provenance data associated with a catalog item to track an individual contribution in a compilation of contributions as indicated by block 78, where the compilation is stored in a memory; and dynamically computing a royalty distribution for the individual contribution as indicated by block 80. Referring also to FIG. 7, a compilation 82 is shown which is located at least partially on the cloud 50. The compilation 82 is formed from a plurality of contributions 82A, 82B . . . 82N. At least a first one of the individual contributions 82A includes provenance data 84. The composition of the compilation 82 may change over time as contributions 82A . . . 82N are changed, or added to, or deleted. In other words, over time the composition of the compilation does not remain the same. The royalty distribution for an individual contribution 82A may be based, at least partially, upon at least one metric related to the contributions which form the compilation. Thus, dynamic computing 80 of a royalty can allow the royalty to change based upon any number of metrics relating to the individual contribution and/or the other contributions and/or the overall compilation. A metric may be defined by a cloud provider as a key indicator of contribution value relative to at least one other contribution of the compilation.

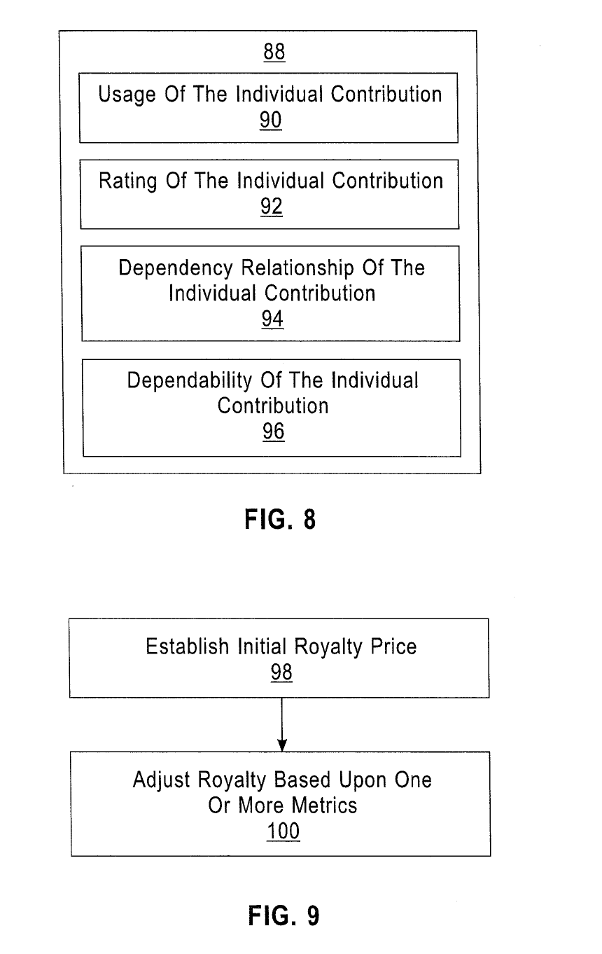

The individual contribution 82A may be stored in a memory in a cloud environment. At least some of the contributions 82A . . . 82N of the compilation 82 may be stored in one or more memories in a cloud environment. Referring also to FIG. 8, various metrics 88 are shown. The at least one metric may include usage 90 of the individual contribution, by at least one user, relative to usage of at least one other of the contributions of the compilation. The at least one metric may include at least one rating 92 of the individual contribution relative to rating(s) of at least one other of the contributions of the compilation. The at least one metric may include a dependency relationship 94 of the individual contribution relative to at least one other of the contributions of the compilation or other catalog item. The at least one metric may include dependability or dependability index 96 of the individual contribution relative to dependability of at least one other of the contributions of the compilation or one or more other catalog items being offered. Dynamically computing the royalty distribution may use a weighting system to determine a royalty distribution value for the individual contribution. Dynamically computing the royalty distribution may occur at different points in time for the individual contribution. The system and method may further comprise determining a total royalty value to be distributed for the individual contribution for a predetermined period of time based upon the dynamically computed royalty distribution over that predetermined period of time.

Features as describe herein may provide a platform to keep track of individual contributors. Provenance data associated with a catalog item may be recorded to keep track of Providers/Contributors to each item and Component/Part(s) of the item a contributor has contributed to. This may be used to enable the providers to recommend price(s) for their component(s) when the contribution is standalone composable item. The cloud may be used as a market place in which these components would be put together and offered through the cloud. When a new composed item is added to the catalog, the price may be set by the cloud. For example, an initial price may be set by the cloud based at least on (i) the aggregate of all the individual prices, (ii) a cloud base price and (iii) a profit margin. Relative revenue value may be driven, for example, by whether composed items with that component sell (if the component provider overcharged, use may be limited).

Referring also to FIG. 9, as an example, the method may comprise establishing an initial royalty price for an individual contribution as indicated by block 98, and then adjusting the royalty price as indicated by block 100 based, at least partially, upon one or more of the metrics 88. As an example, if the initial royalty distribution price or value was $0.50 (US) per use for a first month, but usage of the individual contribution by users on the cloud in a subsequent second month is reduced 50 percent relative to the usage of the first month, then the royalty distribution price or value may be reduced to $0.25 (US) per use for that second month. If used ten times the first month, the royalty would be $5.00 (US) for the first month, and if used ten times the second month, the royalty would be $2.50 (US) for the second month. The royalty can be dynamically adjusted based upon one or more metrics relative to the compilation on the cloud.

In one example embodiment the cloud may be used as an effective “middle man” that pulls in the revenue and, based on the contributors account settings, may then parcel out appropriate royalty(ies).

Features as described herein may be used to monitor the usage of individual parts to identify the relative functional value of the contributions when the contribution is not standalone, such as when embedded in a non-standalone item (a compilation). The usage may be leveraged to compare similar functions, such as different approaches for the same report for example. Different metrics may be used, such as lines of code absolute or relative to the rest of the products for example.

Features as described herein may be used to provide a rating support where users can input their evaluation of the Component/Part(s). The rating may be useful for comparing functions that are very different in nature, such as different reports once a month versus once a day.

Features as described herein may be used to dynamically compute royalty distribution. The features may be used to compute the royalty distribution based on, for example:
Normalized resource usage: the more a component is used, the more the contributor of the component may be paid;
User rating: different rating methodologies may measure the value of a component differently; and/or
Dependability: such as strong integration, SLAs, and/or incidents generated.

Features as described herein may be used to enable an entity, such as an offering manager for example, to fine tune the weight of each royalty computation model, such as through a weighting system using the metrics 88 for example. This may use a relationship between the rest of the parts of the compilation and the composed catalog item to give a bigger weight to a more dependable part for example. Features as described herein may use (if available) an open source solution as a benchmark for normalization of the contribution. A final royalty distribution may be computed by combining the weighted metrics.

The system and method may keep track of individual contributors to a catalog item on cloud via provenance data, and dynamically compute a royalty distribution to meet the requirement of paying individual contributors appropriately.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

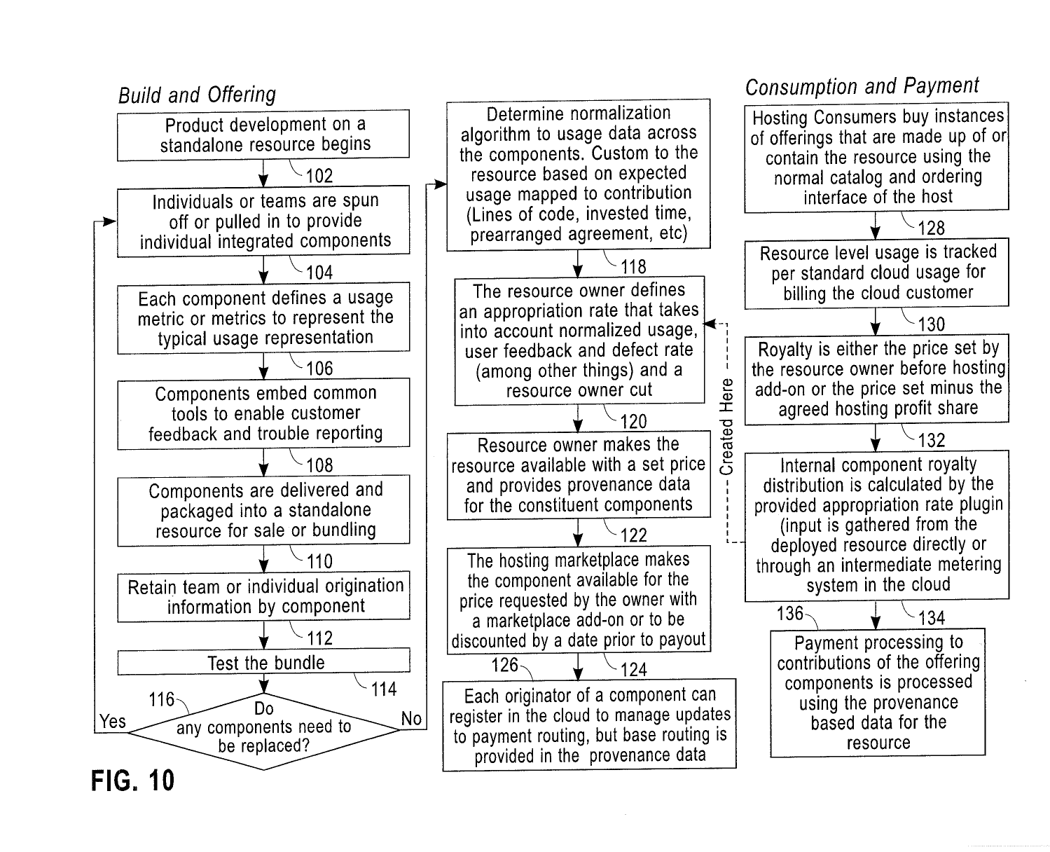

Referring also to FIG. 10, a flow diagram of an example is shown. In this non-limiting example flow, a subflow for Building and Offering 102-126 may comprise:
Product development on a standalone resource begins as indicated by block 102;
Individuals or teams are spun off or pulled in to provide individual integrated components as indicated by block 104;
Each component defines a usage metric or metrics to represent the typical usage representation as indicated by block 106;
Components imbed common tools to enable customer feedback and trouble reporting as indicated by block 108;
Components are delivered and packaged into a standalone resource for sale or bundling as indicated by block 110;
Retain team or individual origination information by component as indicated by block 112;
Test the bundle as indicated by block 114;.
Do any components need to be replaced? as indicated by block 116;
Determine normalization algorithm to usage data across the components. Custom to the resource based on expected usage mapped to contribution (Lines of code, invested time, prearranged agreement, etc) as indicated by block 118;
The resource owner defines an appropriation rate that takes into account normalized usage, user feedback and defect rate (among other things) and a resource owner cut as indicated by block 120;
Resource owner makes the resource available with a set price and provides provenance data for the constituent components as indicated by block 122;
The hosting marketplace makes the component available for the price requested by the owner with a marketplace add-on or to be discounted by a delta prior to payout as indicated by block 124;
Each originator of a component can register in the cloud to manage updates to payment routing, but base routing is provided in the provenance data as indicated by block 126;

And a subflow for Consumption and Payment 128-136 may comprise:
Hosting Consumers buy instances of offerings that are made up of or contain the resource using the normal catalog and ordering interface of the host as indicated by block 128;
Resource level usage is tracked per standard cloud usage for billing the cloud consumer as indicated by block 130;
Royalty is either the price set by the resource owner before hosting add-on or the price set minus the agreed hosting profit share as indicated by block 132;
Internal component royalty distribution is calculated by the provided appropriation rate plugin (Input is gathered from the deployed resource directly or through an intermediate metering system in the cloud) as indicated by block 134;
Payment processing to contributors of the offering components is processed using the provenance based data for the resource as indicated by block 136.

Each component that is used may receive royalty based on some measure (usage metric—resource utilization/demand/LOC/user feedback etc). At the resource level, the resource owner may have a slice separate from component contributors. The composition workflow may include the offering add-on as well as the resource charges. This is how payment/royalty may be calculated for the offering composers who composed the offering/solution (with the components) for their time invested in putting the offering together.

An offering may be created from a previous offering (offering is a component). If separate child offerings contain the same component, there may be some mechanism to reduce/increase the royalty for the common component. The royalty appropriation does not need to change. The component contributor may simply receive part of the revenue from each child offering and would correctly get more because it was being used more due to the dual inclusion.

If a composition of multiple resources is created as an offering, the core price per resource may follow straight through, and the royalty within the resource may retain the original appropriation model for the resource. It is possible to apply the royalty model to this composition as well. The diagram shown in FIG. 10 is a basic model; not all inclusive.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1. A method comprising:
offering for an online transaction a compilation of computer-storable contributions;
identifying an individual contribution to the compilation, where the compilation comprises a plurality of individual contributions stored in a non-transitory computer memory;
determining, at least partially with a computer processor coupled with the computer memory, a royalty distribution value dynamically computed for the identified individual contribution based, at least partially, upon at least one weighted metric regarding the compilation, wherein the weighted metric comprises a comparison of the individual contribution relative to other contributions of the plurality of contributions, the weighted metric being other than usage, and wherein the dynamically computer royalty distribution value changes over time based on the comparison of the individual contribution relative to other contributions of the plurality of contributions.

2. A method as in claim 1 where the individual contribution is stored in a the non-transitory memory in a cloud environment.

3. A method as in claim 1 where the non-transitory memory comprises one or more memories in a cloud environment.

4. (canceled)

5. A method as in claim 1 where the at least one weighted metric includes at least one user assigned rating of the individual contribution relative to rating(s) of at least one other of the plurality of individual contributions of the compilation.

6. A method as in claim 1 where the at least one weighted metric includes a dependency relationship of the individual contribution of the compilation.

7. A method as in claim 1 where the plurality of individual contributions comprise catalog items of a catalog, and the at least one weighted metric includes a dependability index of the individual contribution relative to at least one other of the plurality of individual contributions of the compilation or another catalog item of the catalog being offered.

8. (canceled)

9. A method as in claim 1 further comprising tracking use of the individual contribution.

10. A method as in claim 1 further comprising using provenance data associated with the individual contribution to track the individual contribution.

11. (canceled)

12. A method as in claim 1 further comprising determining a total royalty value to be distributed for the individual contribution for the predetermined period of time based upon the dynamically computed royalty distribution value over that predetermined period of time.

13. A method as in claim 1 where the at least one weighted metric includes a metric defined by a cloud provider as a key indicator of contribution value relative to at least one other of the plurality of individual contributions.

14-24. (canceled)

25. A method as in claim 1 further comprising processing payment of the royalty distribution value for the identified individual contribution.

26. An apparatus, comprising:
one or more processors; and
one or more memories including computer program code,
the one or more memories and the computer program code configured to, with the one or more processors, cause the apparatus to perform at least the following:
identify an individual contribution to a compilation, where the compilation comprises a plurality of individual contributions stored in a non-transitory computer memory;
determine a royalty distribution value dynamically computed over a predetermined period of time for the identified individual contribution based, at least partially, upon at least one weighted metric regarding the compilation, wherein the weighted metric comprises a comparison of the individual contribution relative to other contributions of the plurality of contributions, the weighted metric being other than usage, and wherein the dynamically computer royalty distribution value changes over time based on the comparison of the individual contribution relative to other contributions of the plurality of contributions.

27. An apparatus as in claim 26 where the at least one weighted metric includes at least one user assigned rating of the individual contribution relative to rating(s) of at least one other of the plurality of individual contributions of the compilation.

28. An apparatus as in claim 26 where the at least one weighted one metric includes a dependency relationship of the individual contribution of the compilation.

29. An apparatus as in claim 26 where the plurality of individual contributions comprise catalog items of a catalog, and the at least one weighted metric includes a dependability index of the individual contribution relative to at least one other of the plurality of individual contributions of the compilation or another catalog item being offered.

30. An apparatus as in claim 26 where the one or more memories and the computer program code configured to, with the one or more processors, cause the apparatus to further perform processing payment of the royalty distribution value for the identified individual contribution.

31. A computer program product comprising a non-transitory computer-readable storage medium bearing computer program code embodied therein for use with a computer, the computer program code comprising:
code for identifying an individual contribution to a compilation, where the compilation comprises a plurality of individual contributions stored in a non-transitory computer memory;
code for determining a royalty distribution value dynamically computed over a predetermined period of time for the identified individual contribution based, at least partially, upon at least one weighted metric regarding the compilation, wherein the weighted metric comprises a comparison of the individual contribution relative to other contributions of the plurality of contributions, the weighted metric being other than usage, and wherein the dynamically computer royalty distribution value changes over time based on the comparison of the individual contribution relative to other contributions of the plurality of contributions.

32. A computer program product as in claim 31 where the at least one weighted metric includes usage of the individual contribution, by at least one user, relative to usage of at least one other of the plurality of individual contributions of the compilation.

33. A computer program product as in claim 31 where the at least one weighted metric includes at least one rating of the individual contribution relative to rating(s) of at least one other of the plurality of individual contributions of the compilation.

34. A computer program product as in claim 31 where the at least one weighted metric includes a dependency relationship of the individual contribution of the compilation.

35. A computer program product as in claim 31 where the plurality of individual contributions comprise catalog items of a catalog, and the at least one weighted metric includes a dependability index of the individual contribution relative to at least one other of the plurality of individual contributions of the compilation or another catalog item being offered.

36. A computer program product as in claim 31 further comprising code for processing payment of the royalty distribution value for the identified individual contribution.
